(19) United States
(12) Patent Application Publication
(10) Pub. No.: US 2023/0316692 A1
(43) Pub. Date: Oct. 5, 2023

(54) Head Mounted Display with Reflective Surface

(71) Applicant: Hewlett-Packard Development Company, L.P., Spring, TX (US)

(72) Inventor: Robert Paul Martin, Fort Collins, CO (US)

(73) Assignee: Hewlett-Packard Development Company, L.P., Spring, TX (US)

(21) Appl. No.: 18/043,314

(22) PCT Filed: Sep. 14, 2020
(86) PCT No.: PCT/US2020/050609

§ 371 Date: Feb. 27, 2023

(51) Int. Cl. G06V 10/147; H04N 23/667; G06F 3/01; G06V 40/20; G06V 40/16; H04N 13/254; H04N 13/236

(52) U.S. Cl. CPC G06V 10/147; H04N 23/667; G06F 3/017; G06F 3/012; G06V 40/20; G06V 40/176; H04N 13/254; H04N 13/236; G06F 2203/011; H04N 13/239

(57) ABSTRACT

In an example implementation according to aspects of the present disclosure, an electronic device comprises a display which comprises a head-mountable display (HMD) comprises a reflective surface coupled to a face plate of the HMD. The HMD comprises a light source to project light toward the reflective surface, wherein the projected light is reflected onto a wearer of the HMD by the reflective surface. The HMD also comprises a camera to capture an image of the wearer as reflected by the projected light from the reflective surface and a processor to identify a gesture of the wearer within the captured image of the wearer.

### BACKGROUND

Extended reality (XR) technologies include virtual reality (VR), augmented reality (AR), and mixed reality (MR) technologies. XR technologies may use head mounted display (HMDs). An HMD is a display device that may be worn on the head. In VR technologies, the HMD wearer is immersed in a virtual world. In AR technologies, the HMD wearer's direct or indirect view of the physical, real-world environment is augmented. In MR technologies, the HMD wearer experiences a mixture of real-world and virtual-world environments.

### BRIEF DESCRIPTION OF THE DRAWINGS

Many aspects of the disclosure can be better understood with reference to the following drawings. While several examples are described in connection with these drawings, the disclosure is not limited to the examples disclosed herein.

FIGS. 1A-1B illustrate a head mounted display (HMD) with a reflective surface to capture an image of an HMD, according to an example;

FIG. 2 illustrates a diagram of an HMD with a reflective surface to capture an image of a wearer of the HMD, according to an example;

FIG. 3 illustrates a block diagram of a non-transitory readable medium storing machine-readable that upon execution cause a system to transfer gesture image data to an external computing system to animate an expressive avatar of a wearer of an HMD with a reflective surface, according to another example;

FIG. 4 illustrates a diagram of an HMD with a dual-planar mirror to capture side-by-side stereo images of a wearer of the HMD, according to an example; and

FIG. 5 illustrates a flow diagram of a method of using multiple cameras to capture multiple images of a wearer of an HMD with a reflective surface, according to some examples.

### DETAILED DESCRIPTION

A head mounted display (HMD) can be employed as an extended reality (XR) technology to extend the reality experienced by the HMD's wearer. An HMD can include a small panel in front of the eyes of a wearer of the HMD to project images which immerse the wearer of the HMD with virtual reality (VR), augmented reality (AR), mixed reality (MR), or another type of XR technology. An HMD may also include outward facing cameras to capture images of the environment or external/inward facing cameras to capture images of the user.

Capturing images of a user allows facial expressions and gestures to be identified. The facial expressions and gestures may be used to create an expressive or emotive avatar of the user. In particular, the lower part of a user's face can be highly expressive and provide valuable data for mimicking expressions and gestures of the user using the expressive avatar. Therefore, high accuracy of data indicating a user's facial expressions and/or upper body gestures is needed.

Several techniques for capturing a user's facial expressions involve using a camera. In one technique, a camera may be placed near the nose piece of the HMD and directed in a downward motion toward the lower part of the user's face. Another technique may involve placing the camera away from the user's face (e.g., extending the camera out with an arm from the HMD, using an external camera, etc.). However, these techniques generally generate a steep vertical angle between the camera and the lower part of the user's face which may result in a portion of the user's face being obscured. For example, a mustache or upper lip may obscure a lower lip or inside of the mouth from view by the camera. Therefore, the more horizontal the line of sight of the camera is, the more the camera can directly view the user's face. Furthermore, having a more direct view of the user's face and/or upper body may assist in capturing depth information associated with the user's face and/or upper body.

Unfortunately, getting a more horizontal angle between the camera and the user's face would require a camera to be placed a further distance from the HMD that the user is wearer (e.g., placing the camera on an adjustable arm that is attached to the HMD). This can cause the HMD to become overly heavy in the front and cause the HMD to have additional straps and equipment to secure the HMD to the user's head. Furthermore, adding additional wiring onto the arm to the camera can lead to an increase likelihood of electrical failures, as more wires are placed in a vulnerable position on the HMD. Additionally, increasing the size of an arm on the HMD, or even having an arm at all, can be awkward and inconvenient for the user wearing the HMD. There is also a high likelihood of the arm being broken off or damaged.

The HMD may instead use a camera which is attached to the HMD near the face of the user and a reflective surface which is attached to the front plate or panel of the HMD. For instance, a camera may be placed near the nose support of the HMD and a mirror may be hung down from the bottom edge of the front plate of the HMD. The mirror may reflect the lower face of the user back to the camera. This allows the camera to capture a more horizontal view of the user's lower face while installing the camera directly to the base of the HMD, instead of an arm extending from the HMD. This also allows the HMD to maintain a light weight and compact structure. In some instances, the mirror can be attached to the front plate by a hinge. In this regard, the mirror can be flipped up and secured to the bottom surface of an enclosure of the HMD when not in use.

The HMD may become even more compact when the camera is placed to the side of the nose structure of the HMD. By using a dual-planar reflective surface, a side-by-side stereo image (i.e., two images) may be captured by the camera. In other instances, by using an arbitrarily complex reflective surface, a contoured image may be captured by the camera. The side-by-side or contoured image reflected back to the camera allows stereoscopy to be performed which may provide even more depth data about the user's facial expressions. Therefore, not only is the angle of the camera more directly positioned toward the user's face, but there is improved depth information. The improved depth information may assist in creating a three-dimensional (3D) image from the side-by-side stereo images.

Various examples described herein relate to an HMD which comprises a reflective surface coupled to a face plate of the HMD. The HMD comprises a light source to project light toward the reflective surface, wherein the projected light is reflected onto a wearer of the HMD by the reflective surface. The HMD also comprises a camera to capture an image of the wearer as reflected by the projected light from the reflective surface and a processor to identify a gesture of the wearer within the captured image of the wearer.

In other examples described herein, a non-transitory computer-readable medium comprises a set of instructions that when executed by a processor, cause the processor to capture an image of a wearer of an HMD as reflected by a reflective surface coupled to the HMD. Gesture image data of the wearer is identified within the captured image of the wearer and transferred to an external computing system to animate an expressive avatar of the wearer.

In yet another example, a method comprises capturing a first image by a fist camera of a wearer of an HMD as reflected by a first side of a reflective surface coupled to the HMD, capturing a second image by a second camera of the wearer of the HMD as reflected by a second side of the reflective surface coupled to the HMD, identifying a facial expression of the wearer based on the first image of the wearer and the second image of the wearer, and animating an expressive avatar of the wearer based on the identified facial expression of the wearer.

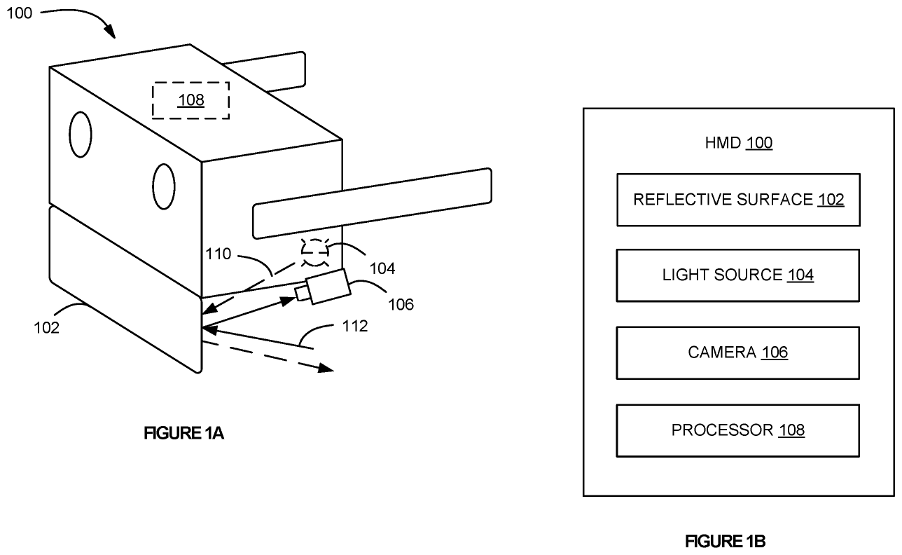

FIGS. 1A-1B illustrate an HMD with a reflective surface to capture an image of an HMD, according to an example. HMD 100 includes reflective surface 102, light source 104, camera 106, and processor 108. FIG. 1A also illustrates projected light 110 (i.e., see dotted-lined arrows) from light source 104 and camera line of sight 112 (i.e., see solid-lined arrows) as viewed by camera 106. HMD 100 may be a virtual reality (VR) device, an augmented reality (AR) device, and/or a mixed reality (MR) device. HMD 100 may be able to process images of the user or transmit image and/or identified gesture data to another computing device to animate an expressive of the user. However, the gesture data may also be used to authenticate the user of HMD 100. In yet another example, the gesture data may be used to determine an emotional state of the user.

The expressive avatar may be used to display facial or body expressions to the user HMD 100 or to other users interacting with the user of HMD 100. The expressive avatar may also be used to perform functions related to HMD 100 or a computing device interacting with HMD 100, such as communicate with other XR equipment (e.g., VR headsets, AR headsets, XR backpacks, etc.), a desktop or notebook PC, tablet, control a robotic computing device, authenticate a security computing device, train an Artificial Intelligence (Al) computing device, and the like.

As illustrated in FIG. 1A, HMD 100 may include an enclosure that partially covers the field of view of the user. The enclosure may hold a display that visually enhances or alters a virtual environment for the user of HMD 100. In some scenarios, the display can be a liquid crystal display, a light-emitting diode (OLED) display, or some other type of display that permits content or graphics to be displayed to the user. The display may cover a portion of the user's face, such as the portion above the mouth and/or nose of the user. HMD 100 may also include a head strap which allows the enclosure of HMD 100 to be secured to the upper portion of the user's face. In some instances, HMD 100 may also include sensors or additional devices which may detect events and/or changes in the environment and transmit the detected events to processor 108.

Still referring to FIGS. 1A-1B, reflective surface 102 is coupled to the front plate of HMD 100. Reflective surface 102 may be a surface which is capable of reflecting an image of the wearer (often referred herein as the “user”) to camera 106. For example, reflective surface 102 may be comprised of glass, plastic, metal, or any other material which can reflect light (e.g., visible light waves, infrared (IR) light waves, etc.) back to camera 106 and allow camera 106 to view images of the user's facial expressions and/or upper body gestures. Reflective surface 102 may be the same size or smaller as the bottom of the enclosure of the display for HMD 100. However, reflective surface 102 may also be extendable to allow an increased amount of the user's body to be reflected in reflective surface 102.

Reflective surface 102 may be positioned parallel to the user's body. This allows an image of the user's face and/or upper body to be reflected back to camera 106. However, in some instances, the position of reflective surface 102 may be angled upward or downward to capture images of different portions of the user wearing HMD 100. For example, if reflective surface 102 is tilted upward, the images captured by camera 106 may be focused on the user's mouth expressions. However, if reflective surface 102 is tilted downward, the images captured by camera 106 may be focused on a user's upper body gestures.

Reflective surface 102 may be attached to the enclosure of HMD 100 by a hinge or latching mechanism. For example, reflective surface 102 may be attached to the bottom edge of front plate or face plate of HMD 100 by a hinge which allows reflective surface 102 to be opened and closed. When reflective surface 102 is opened, reflective surface 102 may be flipped down to a vertical position which faces the lower portion of the user's face. In this position, reflective surface 102 may reflect the user's face back to camera 106. However, when reflective surface 102 is closed, reflective surface 102 may be flipped up to a horizonal position which is parallel to the bottom surface of the enclosure holding the display in HMD 100.

In other examples, reflective surface 102 may be detachable. In this example, reflective surface 102 may be attached to HMD 100 using a latching mechanism when in use. In yet another example, reflective surface 102 may act as a physical privacy switch when in a closed position where the line of sight for camera 106 is covered if not in use. In other examples, the state of camera 106 may be turned on or off based on the position of reflective surface 102 (e.g., if reflective surface 102 is flipped upward, camera 106 may be directed to be turned off or put into a sleep mode).

Reflective surface 102 may also function as a visible or audio shield of the lower facial region for the user of HMD 100. For example, a user using VR conferencing in a public place may not want bystanders to be able to lip read what the user is saying during the call. In this scenario, reflective surface 102 may act as a visual shield for the mouth of the user of HMD 100.

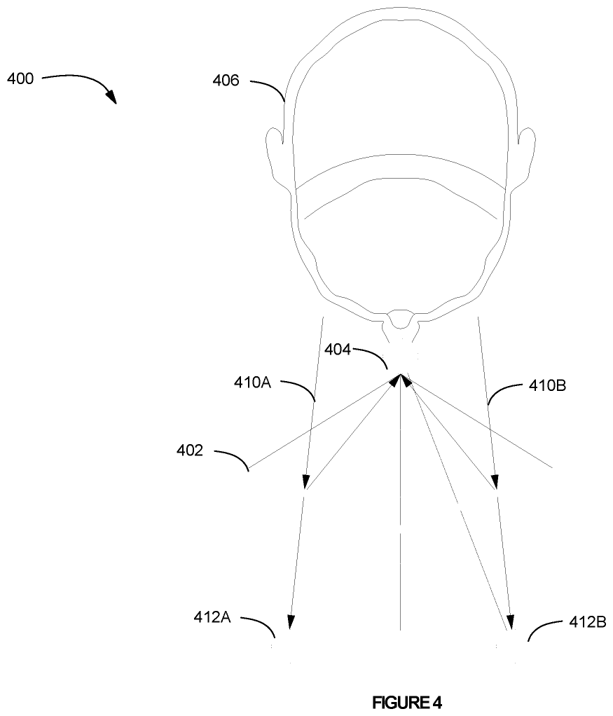

In some examples, reflective surface 102 may comprise a dual-planar reflective surface. For example, a reflective surface may be bent in half to have two side-by-side reflective surfaces or include two adjoining reflective surfaces. The dual-planar mirror may allow a side-by-side image to be seen by camera 106. This may allow camera 106 to be placed to one side of the user's nose and still be able to view both sides of the user's face by deciphering and separating out the image data for the two images and then performing stereo imaging. By performing stereo imaging, additional depth information may be collected and processed to generate a 3D view of an expressive avatar using the facial expressions and/or upper body gestures acted out by a user. This example scenario is discussed in further detail in FIG. 4.

In other examples, reflective surface 102 may comprise an arbitrarily complex reflective surface. This would allow camera 106 to view a contoured image which focuses in on specified areas of the user's face. For example, reflective surface 102 may be shaped to accentuate the mouth region of the user's face in the images captured by camera 106. The arbitrarily complex reflective surface may also be tuned to focus in on different parts of a user's face or upper body, or even be tuned to adjust to the different face structures/sizes of the users. By using a dual-planar reflective surface and/or an arbitrarily complex reflective surface to capture the user's facial expressions, a more direct view of the user is available, as well as more depth information is captured by camera 106 in the images.

Light source 104 may comprise any device capable of projecting light onto reflective surface 102 and illuminate portions of a user's face and/or upper body using projected light 110 (e.g., see dotted-line arrows in FIG. 1). For example, light source 104 may be a light emitting diode (LED) illuminator, a lamp, a laser, etc. In some scenarios, light source 104 may project light in the visible spectrum or in the non-visible spectrum, such as an IR illuminator, or an ultraviolet (UV) illuminator. By projecting the light onto the user's face and/or upper body using reflective surface 102, an improved illumination angle may be created which allows the user's features to be more consistently illuminated (e.g., lowers shadowing below the user's upper or lower lip). It should also be noted that in other examples, light source 104 may emit diffused light onto reflective surface 102. However, in other examples, light source 104 may emit structured light onto reflective surface 102.

Camera 106 captures images of the user's face and/upper body, as illuminated by the light that light source 104 projects off of reflective surface 102 (e.g., see solid arrows in FIG. 1). Camera 106 can be a still image or a moving image (i.e., video) capturing device. Examples of camera 106 include semiconductor image sensors like charge-coupled device (CCD) image sensors and complementary metal-oxide semiconductor (CMOS) image sensors. By reflecting the image of the user's lower face and/or upper body off of reflective surface 102, an increased virtual distance is created between the camera and the user's face which improves the viewing angle of the images captured by camera 106.

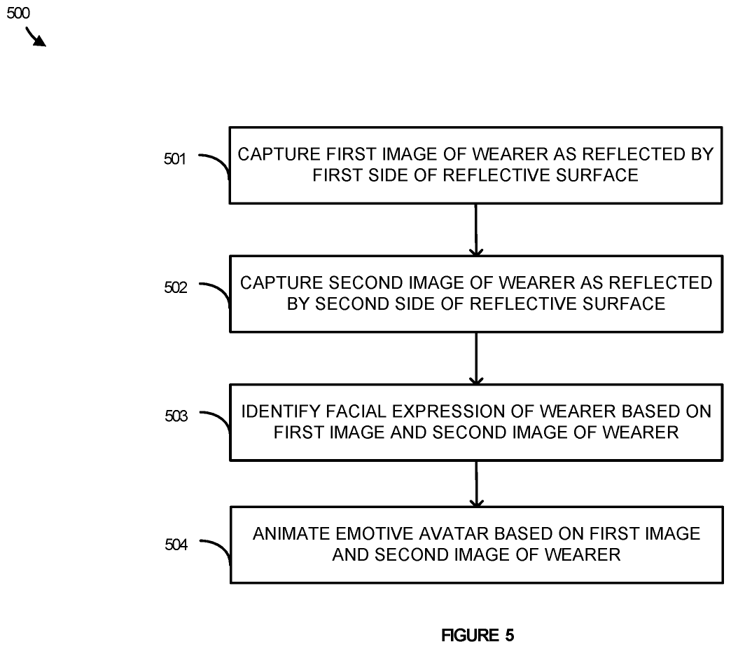

Camera 106 may be located near the nose structure of HMD 100, or near where the enclosure holding the display of HMD 100 connects with the face of the user. In some examples, camera 106 is placed to one side of the user's face/nose. In this example, a side-by-side image may be captured by camera 106 using a dual-planar reflective surface. In other examples, camera 106 may be centered on the user's face. In yet another example, HMD 100 may include one or more additional cameras. In this example, each camera may be placed on either side of the user's face. This example is further illustrated in FIG. 5 herein.

Processor 108 may include a processing system and/or memory which store instructions to perform particular functions. In particular, processor 108 may direct light source 104 to project light onto reflective surface 102. Processor 108 may also direct camera 106 to capture images of the user of HMD 100. Processor 108 may use the images captured by camera 106 to determine gestures performed by the user and animate an expressive avatar.

Processor 108 may extract data from the captured images. For example, processor 108 may determine control points for the user by using a grid system and locating coordinates which correspond to different points of the user's face or upper body. In some examples, processor 108 may be able to identify a user gesture, such as a smile. In either scenario, the extracted data may be used to animate an expressive avatar of the user, to authenticate a user, to determine an emotional state of the user, etc. For example, reference points may be identified and compared to stored reference points to determine that the gesture is a smile. In this scenario, HMD 100 may use the gesture data to determine that the user is happy.

The expressive avatar may be animated by an external processing system (e.g., laptop computer system of the user or of other users, a cloud computing system, etc.). In this scenario, the extracted data may be transferred to the external processing system. Further in this example, the data may be compressed before transfer, especially if processor 108 is able to identify the gesture locally (e.g., identification of the smile). In other examples, processor 108 may be able to process the extracted data and generate the expressive avatar.

Processor 108 may also be able to execute a privacy mode for camera 106. The activation of the privacy mode may disable content from being displayed in a region of the panel. Processor 108 may be coupled to camera 106 and communicate instructions to enable and disable a privacy mode for camera 106 based on the position of reflective surface 102.

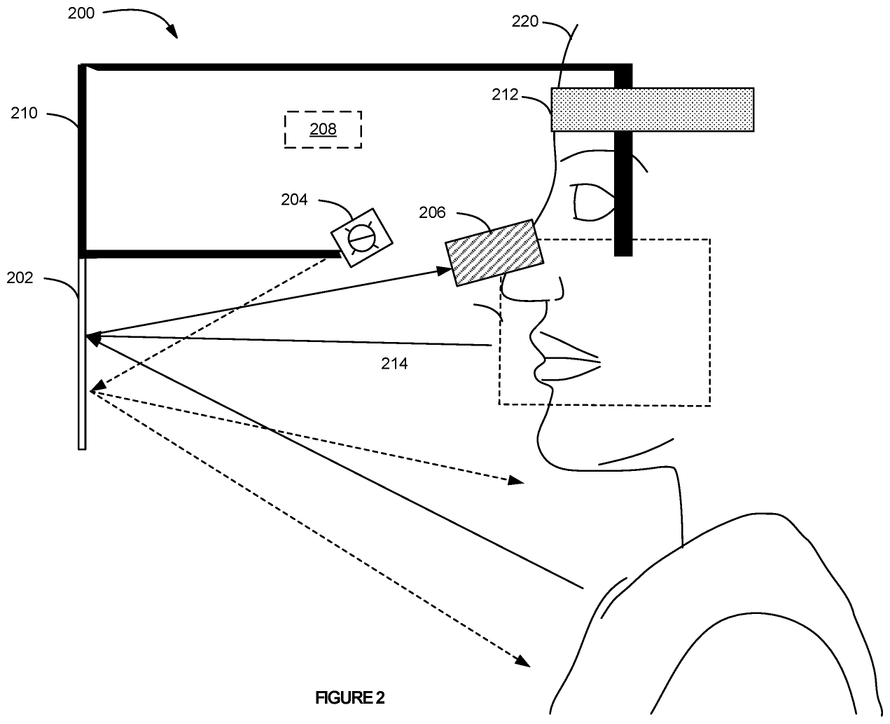

FIG. 2 illustrates a diagram of an HMD with a reflective surface to capture an image of a wearer of the HMD, according to an example. FIG. 2 includes HMD 200 and user 220. HMD 200 may be an example of HMD 100 from FIGS. 1A-1B. However, HMD 200 and the components included in HMD 200 may differ in form or structure from HMD 100 and the components included in HMD 100.

HMD 200 includes reflective surface 202, illuminator 204, camera 206, and processor 208. HMD 200 also includes enclosure 210 and head strap 212. The lower portion of user's 220 face is indicated by the dotted rectangle, lower facial portion 214. Specifically, reflective surface 202 is attached to the front plate of enclosure 210 of HMD 200. Illuminator 204 and camera 206 are attached to the bottom surface of enclosure 210 of HMD 200.

As indicated by the dotted-line arrows, illuminator 204 projects light onto lower facial portion 214 of user 220 by reflecting the light onto reflective surface 202. As indicated by the solid-line arrows, camera 206 captures images of lower facial portion 214 of user 220 by capturing reflected images off of reflective surface 202. Processor 208 identifies gestures (i.e., facial expressions and/or upper body movements) of user 220 based on the images captured by camera 206.

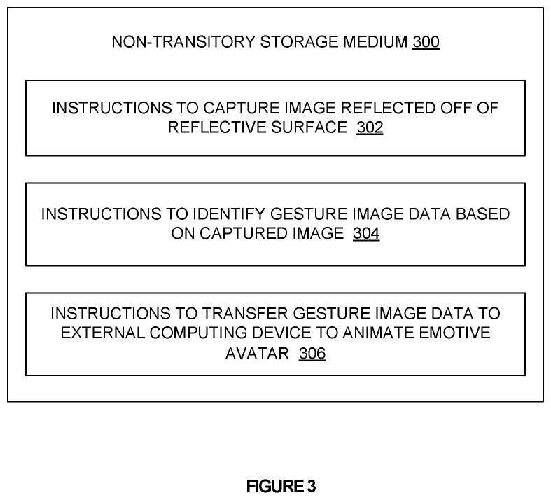

FIG. 3 illustrates a block diagram of a non-transitory readable medium storing machine-readable that upon execution cause a system to animate an expressive avatar of a wearer of an HMD with a reflective surface, according to another example. Storage medium is non-transitory in the sense that is does not encompass a transitory signal but instead is made up of a memory component configured to store the relevant instructions.

The machine-readable instructions include instructions 302 to capture an image of a wearer of an HMD as reflected by a reflective surface coupled to the HMD. The machine-readable instructions also include instructions 304 to identify a facial expression of the wearer within the captured image of the wearer. Furthermore, the machine-readable instructions also include instructions 306 to transfer image data to an external computing device to animate an expressive avatar of the wearer based on the identified gesture of the wearer.

In one example, program instructions 302-306 can be part of an installation package that when installed can be executed by a processor to implement the components of a computing device. In this case, non-transitory storage medium 300 may be a portable medium such as a CD, DVD, or a flash drive. Non-transitory storage medium 300 may also be maintained by a server from which the installation package can be downloaded and installed. In another example, the program instructions may be part of an application or applications already installed. Here, non-transitory storage medium 300 can include integrated memory, such as a hard drive, solid state drive, and the like.

FIG. 4 illustrates a diagram of an HMD with a dual-planar mirror to capture side-by-side stereo images of a wearer, according to an example. FIG. 4 includes system 400. System 400 includes dual-planar mirror 402, camera 404, and user 406. FIG. 4 also includes camera line of sights 410A-410B and virtual camera locations 412A-412B.

Virtual camera locations 412A-412B illustrate the line of sight angle and line of sight distance which is captured if camera 404 was not using dual-planar mirror 402. For example, the angle of line of sight 410A may be twice the angle that would be available if camera 404 were placed at the distance dual-planar mirror 402 is from the face of user 406. Furthermore, by using dual-planar mirror 402, the length of line of sight 410A is twice as long as the length of the line of sight if camera 404 were placed at the distance dual-planar mirror 402 is from the face of user 406.

In operation, camera 404 captures images of user 406 using dual-planar mirror 402. Specifically, camera 404 may capture a first image of user 406 using line of sight 410A reflecting off of a first side of dual-planar mirror 402. The first image may be comparable to an image that virtual camera 412A would capture if directed at the face of user 406.

Similarly, a second image of user 406 may be captured by camera 404 using line of sight 410B reflecting off of the second side of dual-planar mirror 402. In system 400, stereoscopics may be performed using the two captured images to identify the facial expressions and/or upper body gestures acted out by user 406. By performing stereo imaging, additional depth information may be collected and processed to generate a 3D view of an expressive avatar using the facial expressions and/or upper body gestures acted out by user 406.

FIG. 5 illustrates a flow diagram of a method of using multiple cameras to capture multiple images of a wearer of an HMD with a reflective surface, according to some examples. Method 500 is associated with examples discussed herein with regard to FIGS. 1-4, and details of the operations shown in this method can be found in the related discussion of such examples. Some or all of the blocks of method 500 may be implemented in program instructions in the context of a component or components of an application used to carry out the enabling a private viewing zone for a display.

Although the flow diagram of FIG. 5 shows a specific order of execution, the order of execution may differ from that which is depicted. For example, the order of execution of two of more blocks shown in succession by be executed concurrently or with partial concurrence. All such variations are within the scope of the present disclosure.

Referring parenthetically to the blocks in FIG. 5, method 500 provides capturing a first image of a wearer of an HMD as reflected by a first side of a reflective surface coupled to the HMD, at block 501. For example, a first camera, such as camera 106, may be placed to the left side of the face of an HMD user. Like previous examples, the first camera is directed toward a reflective surface or mirror which is attached to the front enclosure/plate of the HMD, such as reflective surface 102. The first camera can then receive image data for the user's face or upper body via the image created reflective surface. This allows for an angle between the user's face and the line of sight of the camera to become less steep and the distance of the line of sight to be longer. However, the other side of the user's face may be obscured from view by the user's nose or by the front enclosure of the HMD.

Method 500 further includes capturing a second image of the wearer of the HMD as reflected by a second side of the reflective surface coupled to the HMD, at block 502. For example, the second camera may be placed to the right side of the user of the HMD's face. The second camera is also directed toward the reflective surface attached to the HMD. The second camera then receives image data for the other side of the user's face or upper body. Again, this allows for a more horizontal angle for the second camera's line of sight to the user's face and for a longer line of sight distance. Furthermore, by using two cameras, the cameras may be placed closer to the user's face or to be integrated closer to the base of the enclosure holding the display in the HMD. This allows the HMD to be more compact without comprising the area of the face which can be captured using the cameras.

At block 503, method 500 provides identifying a facial expression of the wearer based on the first image of the wearer and the second image of the wearer. The facial expression of the user may be identified by a controller or one or more processing systems, such as processor 108. The facial expression of the wearer may be determined by using stereo imaging from each of the two images captured by the first and second camera. This ensures that a full view of the face can be viewed to determine what the user's facial expressions are. This may also allow for increased depth information which can in turn improve the processor's ability to identify what the user's facial expressions are.

Method 500 provides animating an expressive avatar of the wearer based on the identified facial expression of the wearer, at block 504. The expressive avatar of the wearer may be animating using an application or service running on the processor in the HMD, or an external processing system (e.g., a laptop computer, cloud server, etc.) which exchanges data with the HMD. The expressive avatar may be animated back to the user or to other users interacting with the user of the HMD and who are able to view the user of the HMD using a display, such as other HMDs or displays on a computing device (e.g., desktop computing, laptop, touchpad, etc.).

The functional block diagrams, operational scenarios and sequences, and flow diagrams provided in the Figures are representative of example systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. Those skilled in the art will understand and appreciate that a method could alternatively be represented as a series of interrelated states or events, such as in a state diagram. Moreover, not all acts illustrated in a methodology may be included as a novel example.

It is appreciated that examples described may include various components and features. It is also appreciated that numerous specific details are set forth to provide a thorough understanding of the examples. However, it is appreciated that the examples may be practiced without limitations to these specific details. In other instances, well known methods and structures may not be described in detail to avoid unnecessarily obscuring the description of the examples. Also, the examples may be used in combination with each other.

Reference in the specification to “an example” or similar language means that a particular feature, structure, or characteristic described in connection with the example is included in at least one example, but not necessarily in other examples. The various instances of the phrase “in one example” or similar phrases in various places in the specification are not necessarily all referring to the same example.

What is claimed is:

1. A head-mountable display (HMD) comprising:
a reflective surface coupled to a face plate of the HMD;
a light source to project light toward the reflective surface, wherein the projected light is reflected onto a wearer of the HMD by the reflective surface;
a camera to capture an image of the wearer as reflected by the projected light from the reflective surface; and
a processor to identify a gesture of the wearer within the captured image of the wearer.

2. The HMD of claim 1, wherein the processor is to animate an expressive avatar of the wearer based on the identified gesture of the wearer.

3. The HMD of claim 1, wherein the processor is to determine an emotional state of the wearer based on the identified gesture of the wearer.

4. The HMD of claim 1, wherein the processor is to authenticate the wearer based on the identified gesture of the wearer.

5. The HMD of claim 1, wherein the reflective surface comprises a dual-planar reflective surface, and wherein the captured image comprises a side-by-side stereo image.

6. The HMD of claim 1, wherein the reflective surface comprises an arbitrarily complex reflective surface, and wherein the captured image comprises a contoured image.

7. The HMD of claim 1, wherein the camera is positioned to a first side of a nose of the wearer, and further comprising an additional camera positioned to a second side of the nose of the wearer.

8. The HMD of claim 1, wherein the reflective surface coupled to the front plate of the HMD includes a hinge to enable the reflective surface to move from a first position located perpendicular to a face of the wearer to a second position located parallel to the face of the wearer of the HMD.

9. The HMD of claim 6, wherein a privacy mode is activated for the camera of the HMD when the reflective surface in the first position located perpendicular to the face of the wearer of the HMD.

10. A non-transitory computer-readable medium comprising a set of instructions that when executed by a processor, cause the processor to:
capture an image of a wearer of a head mounted display (HMD) as reflected by a reflective surface coupled to the HMD;
identify gesture image data based on the captured image of the wearer; and
transfer the gesture image data to an external computing device for animating an expressive avatar of the wearer.

11. The non-transitory computer readable medium of claim 10, wherein the reflective surface comprises a dual-planar reflective surface, and wherein the captured image comprises a side-by-side stereo image.

12. The non-transitory computer readable medium of claim 10, wherein the reflective surface comprises an arbitrarily complex reflective surface, and wherein the captured image comprises a contoured image.

13. The non-transitory computer readable medium of claim 10, wherein the camera is positioned to a first side of a nose of the wearer, and further comprising an additional camera positioned to a second side of the nose of the wearer.

14. The non-transitory computer readable medium of claim 10, wherein the camera is positioned to a first side of a nose of the wearer, and further comprising an additional camera positioned to a second side of the nose of the wearer.

15. A method comprising:
capturing a first image of a wearer of a head mounted display (HMD) as reflected by a first side of a reflective surface coupled to the HMD;
capturing a second image of the wearer of the HMD as reflected by a second side of the reflective surface coupled to the HMD;
identifying a facial expression of the wearer based on the first image of the wearer and the second image of the wearer; and
animating an expressive avatar of the wearer based on the identified facial expression of the wearer.
